(19) United States
(12) Patent Application Publication
(10) Pub. No.: US 2015/0317286 A1
(43) Pub. Date: Nov. 5, 2015

(54) COMMUNICATIONS APPARATUS AND MULTI-WINDOW DISPLAY METHODS

(71) Applicant: MediaTek Singapore Pte. Ltd., Singapore (SG)

(72) Inventors: Hongwei WANG, Beijing City (CN); Tzu-Wen CHANG, Taipei City (TW)

(21) Appl. No.: 14/699,314

(22) Filed: Apr. 29, 2015

(30) Foreign Application Priority Data
Apr. 30, 2014 (CN) 201410182657.4

(51) Int. Cl. G06F 17/21; G06F 3/0484

(52) U.S. Cl. CPC G06F 17/212; G06F 3/04847; G06F 3/04842

(57) ABSTRACT

A communications apparatus and multi-window display method are provided. The multi-window display method is applied for a communication device, wherein the multiple windows include a first display window configured to display a first application. The multi-window display method includes: obtaining first configuration information of the first application to determine whether a first display mode corresponding to the first application has been set in the first configuration information; setting a first display configuration of the first application according to the first display mode when the first display mode has been set in the first configuration information, or setting the first display configuration according to a first default display configuration when the first display mode has not been set in the first configuration information; configuring the first display window of the first application according to the first display configuration, and displaying the first display window.

### CROSS REFERENCE TO RELATED APPLICATIONS

This application claims the priority of China Patent Application No. 201410182657.4, filed on Apr. 30, 2014, the entirety of which is incorporated by reference herein.

### BACKGROUND OF THE INVENTION

1. Field of the Invention

The invention generally relates to multi-window display technology, and more particularly, to a multi-window display method and a communication device which supports the multi-window display method.

2. Description of the Related Art

In recent years, due to the development of wireless communication technology, there are more and more types of portable and handheld devices, such as mobile phones, smartphones, personal digital assistants (PDAs) and Tablet PCs, and they have become more and more technically advanced and multifunctional. Due to the increased convenience and functionality of these devices, they have become necessities in life.

Current communication devices can support the multi-window display function. Such a communication device is capable of displaying multiple windows corresponding to multiple applications at the same time so that multiple users can operate different applications on the device at the same time, or a single user can operate different applications on this device at the same time. However, so far as now the current communication device can't display different applications which are displayed in different display modes at the same time. That is because applications usually have been set to a fixed display mode by application developers. For example, the display mode of an application may be a landscape mode or portrait mode. The landscape mode indicates that the display window of the application is always displayed horizontally, wherein the horizontal width of this display window is longer than the vertical width of this display window. The portrait mode indicates that the display window of the application is always displayed vertically, wherein the vertical width of this display window is longer than the horizontal width of this display window. However when the applications with different display modes are running on a communication device which supports a multi-window display at the same time, a false display will occur. For example, it is possible for a first application using landscape mode and a second application using portrait mode to be running at the same time: when the first application is in an active state and the second application is in the suspended mode, due to the display mode of the first application being a landscape mode, the communication device may prepare the landscape display configuration for the first application, and set the display data and display the application window according to the landscape display configuration. In addition, the communication device sets its system display configuration to the landscape display configuration and then displays the other applications (i.e., second application) by the landscape display configuration, wherein the landscape display configuration indicates the configuration information of the display window or page which will be displayed horizontally, and the portrait display configuration indicates the configuration information of the display window or page which will be displayed vertically. However, because the display mode of the second application has already been set to portrait mode, that is, the second application can only be displayed in the portrait mode, the second application can not run in the landscape display configuration, as a result, the second application will fail to be displayed on the screen of the communication device, causing the display window to remain black or an error message to be generated. Conversely, if the second application is in an active state and the first application is in the suspended mode, the first application will also fail to be displayed on the screen of the communication device. It is not convenient for the user. FIG. 1 and FIG. 2 are schematic diagrams of performing different applications which are displayed by different display modes at the same time on the communication device. In FIG. 1, the second application B, which uses the portrait mode, fails to be displayed. In FIG. 2, the first application A, which uses the landscape mode, fails to be displayed.

Therefore, a multi-window display method is needed to display different applications which are displayed in different display modes at the same time on the communication device.

### BRIEF SUMMARY OF THE INVENTION

A communications method and apparatus are provided to overcome the problems mentioned above.

An embodiment of the invention provides a communications apparatus. The communications apparatus supports a display of multiple windows, wherein the multiple windows comprise a first display window configured to display a first application running on the communications apparatus. The communications apparatus comprises a package management module, a activity management module, a window management module and a display module. The package management module is configured to read first configuration information of the first application to determine whether the first configuration information includes a first display mode corresponding to the first application. The activity management module is configured to set a first display configuration of the first application according to the first display mode when the first configuration information includes the first display mode, or to set the first display configuration according to a first default display configuration when the first configuration information doesn't include the first display mode. The window management module is configured to configure the first display window of the first application according to the first display configuration. The display module is configured to display the first display window.

An embodiment of the invention provides a multi-window display method. The multi-window display method is applied to a communication device supporting display of multiple windows, wherein the multiple windows comprise a first display window configured to display a first application running on the communications apparatus. The multi-window display method comprises the following steps. The package management module of the communication device obtains the first configuration information of the first application to determine whether the first configuration information includes a first display mode corresponding to the first application. Then, the activity management module of the communication device sets the first display configuration of the first application according to the first display mode when the first configuration information includes the first display mode, or it sets the first display configuration according to the first default display configuration when the first configuration information doesn't include the first display mode. Then, the window management module of the communication device configures the first display window of the first application according to the first display configuration, and the display module of the communication device displays the first display window.

The multi-window display method of the invention can be applied to displaying applications with different display modes on the communication device at the same time.

Other aspects and features of the invention will become apparent to those with ordinary skill in the art upon review of the following descriptions of specific embodiments of communication transmission methods and systems.

### BRIEF DESCRIPTION OF THE DRAWINGS

The invention will become more fully understood by referring to the following detailed description with reference to the accompanying drawings, wherein:

FIG. 1 and FIG. 2 are schematic diagrams of performing different applications which are displayed by different display modes at the same time on the communication device;

FIG. 3 is a block diagram of a communication device 100 according to an embodiment of the invention;

FIG. 4A is a schematic diagram of displaying a display window of application A on the communication device 100 according to an embodiment of the invention;

FIG. 4B is a schematic diagram of displaying a display window of application B on the communication device 100 according to an embodiment of the invention;

FIG. 4C is a schematic diagram of displaying display windows of application A and application B on the communication device 100 at the same time according to an embodiment of the invention;

FIGS. 4D-4H are schematic diagrams of displaying display windows of application A and application B on the communication device 100 at the same time according to another embodiments of the invention;

FIG. 5 is a flow chart 300 illustrating the multi-window display method according to an embodiment of the invention.

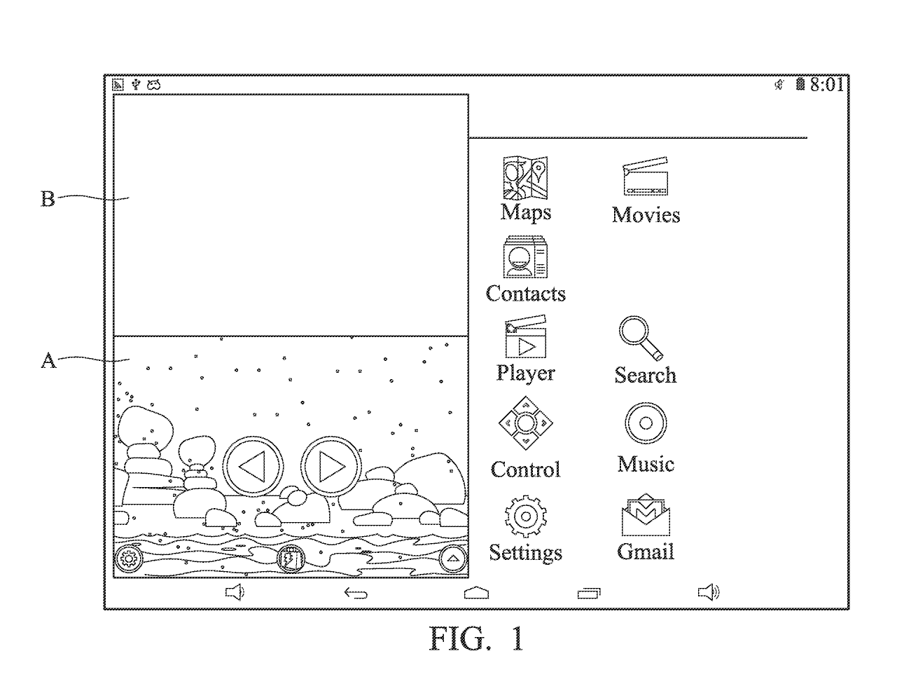

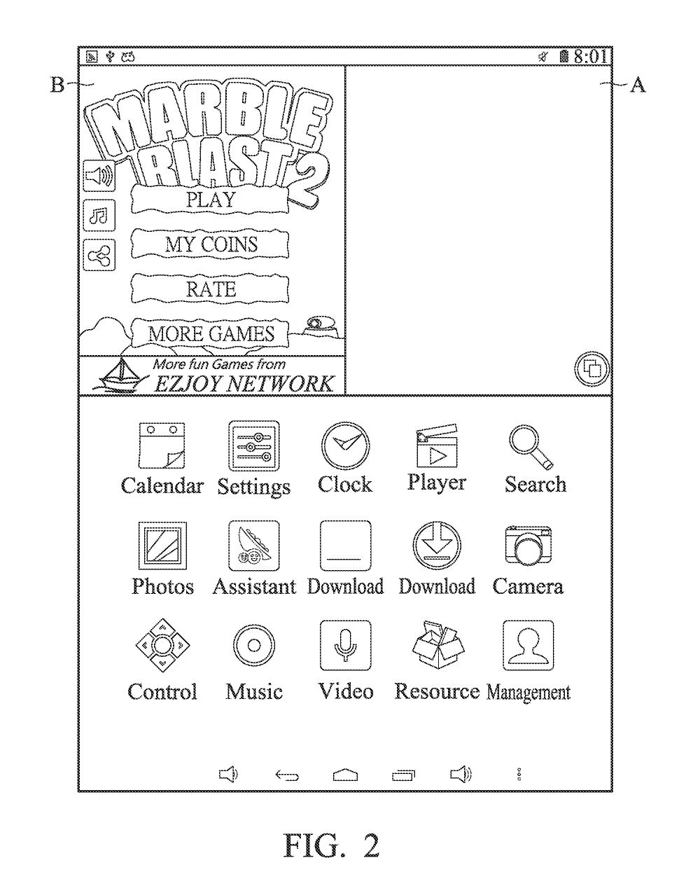

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

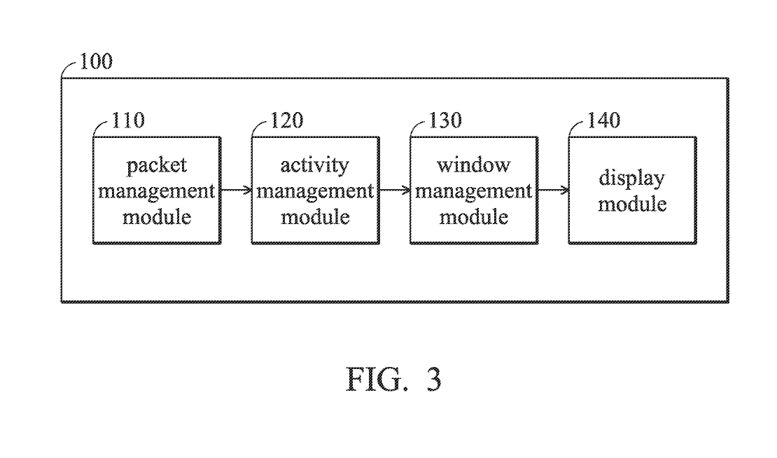

FIG. 3 is a block diagram of a communication device 100 according to an embodiment of the invention. The communication device 100 may be a personal digital assistant (PDA), a smartphone, a tablet PC, etc. As shown in FIG. 3, the communication device 100 comprises a package management module 110, a activity management module 120, window management module 130, and a display module 140. Note that, in order to clarify the concept of the invention, FIG. 3 presents a simplified block diagram. However, the invention should not be limited to what is shown in FIG. 3. For example, the communication device 100 can also comprise a sensing module (not show in FIG. 3) to detect the sensing direction of the communication device 100. Wherein, the method of detecting the sensing direction is performed by using a gravity sensor (G-sensor) or capturing the position of the user's face and eyes through a camera. The sensing direction is a horizontal direction (i.e. horizontal direction) or a longitudinal direction (i.e. vertical direction). After the sensing module detects the direction of the communication device 100, the activity management module 120 will set the system display configuration of the communication device 100 according to the sensing direction. When the sensing direction is a horizontal direction, the activity management module 120 will set the system display configuration of the communication device 100 to the landscape display configuration, and when the sensing direction is a longitudinal direction, the activity management module 120 will set the system display configuration of the communication device 100 to the portrait display configuration. Then, the window management module 130 will configure the system display content according to the display configuration, and the display module 140 will display the system display content.

In an embodiment of the invention, when the communication device 100 runs an application, the package management module 110 is configured to obtain the configuration information of the application and determine whether the display mode of the application has been set in the configuration information. In an embodiment of the invention, the application can be regarded as one of the different software or functions stored in the communication device 100. In an embodiment of the invention, the display mode may be a landscape mode or a portrait mode. The landscape mode indicates that the display window of the application is always displayed horizontally, wherein the horizontal width of this display window is longer than the vertical width of this display window. The portrait mode indicates that the display window of the application is always displayed vertically, wherein the vertical width of this display window is longer than the horizontal width of this display window. Otherwise the display mode of some applications may not be set in advance. That is to say, if the display mode of the application has not been set previously in the configuration information, the display mode of the display window of the application is not to be limited, so that the display mode of the display window of the application can be landscape mode or portrait mode. Then, when the package management module 110 determines that the display mode of the application has been set in the configuration information, the package management module 110 will transmit the display mode information to the activity management module 120 which is coupled with the package management module 110. When the activity management module 120 receives the display mode information, the activity management module 120 will set the display configuration of the application according to the display mode. If the package management module 110 determines that the display mode of the application has not been set in the configuration information, the package management module 110 will notify the activity management module 120 of this information, and then the activity management module 120 will set the display configuration of the application to the default display configuration. In an embodiment of the invention, the default display configuration is a landscape display configuration. In another embodiment of the invention, the default display configuration is a portrait display configuration. In another embodiment of the invention, the default display configuration is a system display configuration, and the activity management module 120 will set the display configuration of the application to the system display configuration. For example, when the system display configuration of the communication device 100 is the landscape display configuration, the activity management module 120 will set the display configuration of the application to the landscape display configuration; and when the system display configuration of the communication device 100 is the portrait display configuration, the activity management module 120 will set the display configuration of the application to the portrait display configuration. In another embodiment of the invention, when the user rotates the communication device 100 to change the sensing direction (e.g. gravity sensing direction) of the communication device 100 from the horizontal direction to the longitudinal direction, the sensing module will detect the change of the direction, and the activity management module 120 will change the display configuration of the application from the landscape display configuration to the portrait display configuration. However, if the package management module 110 determines that the display mode of the application has been set to the landscape mode (or portrait mode) and the activity management module 120 sets the display configuration of the application to the landscape display configuration (or portrait display configuration), the display configuration of the application will not relates to the system display configuration of the communication device 100 or display configurations of other applications which are also being displayed on the display module 140. Namely, the display configuration of the application will not be affected by the communication device 100 or display configurations of other applications which are also being displayed on the display module 140.

When the activity management module 120 has set the display configuration of the application, the activity management module 120 will transmit the display configuration to the window management module 130 which is coupled with the activity management module 120. The window management module 130 configures the display window of the application according to the display configuration of the application after receiving the display configuration. For example, when the display configuration of the application is landscape display configuration, the window management module 130 configures a display window in a horizontal direction to the application; or when the display configuration of the application is portrait mode, the window management module 130 configures a display window in a vertical direction to the application. When the window management module 130 has configured the display window of the application, the management module 130 will transmit the related information of the display window to the display module 140, and then the display module 140 will display the display window of the application.

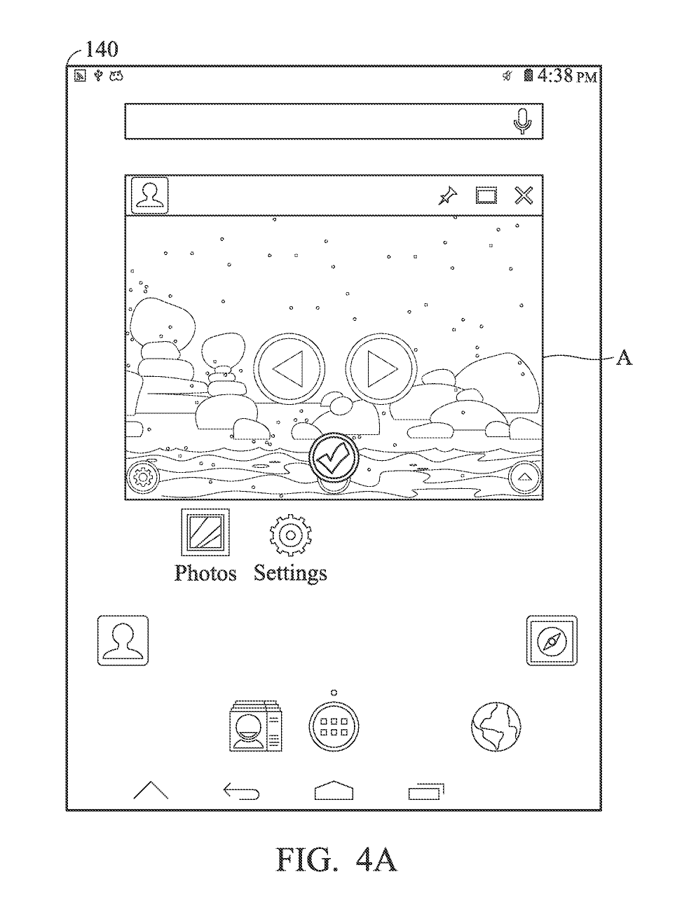

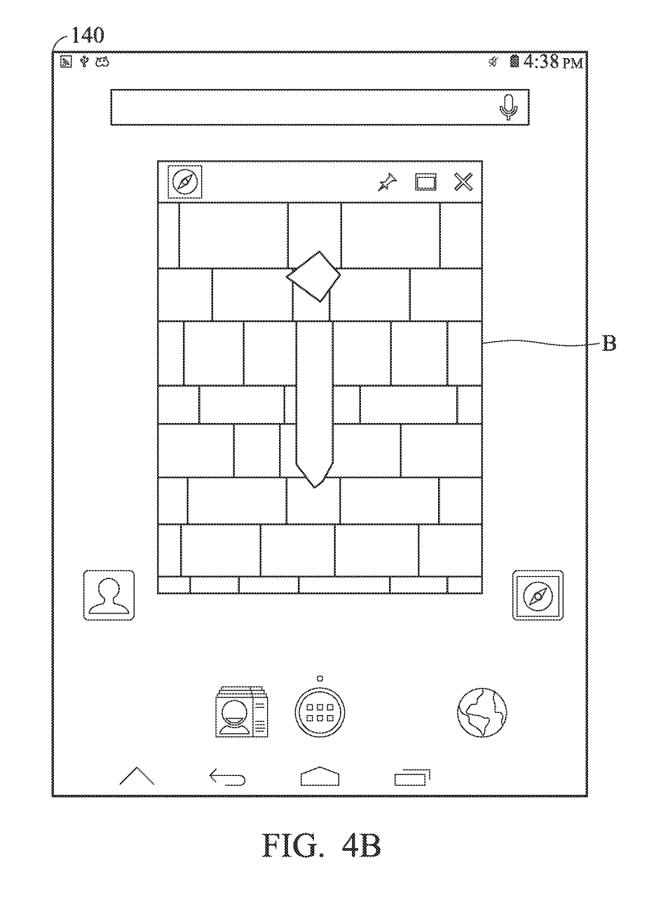

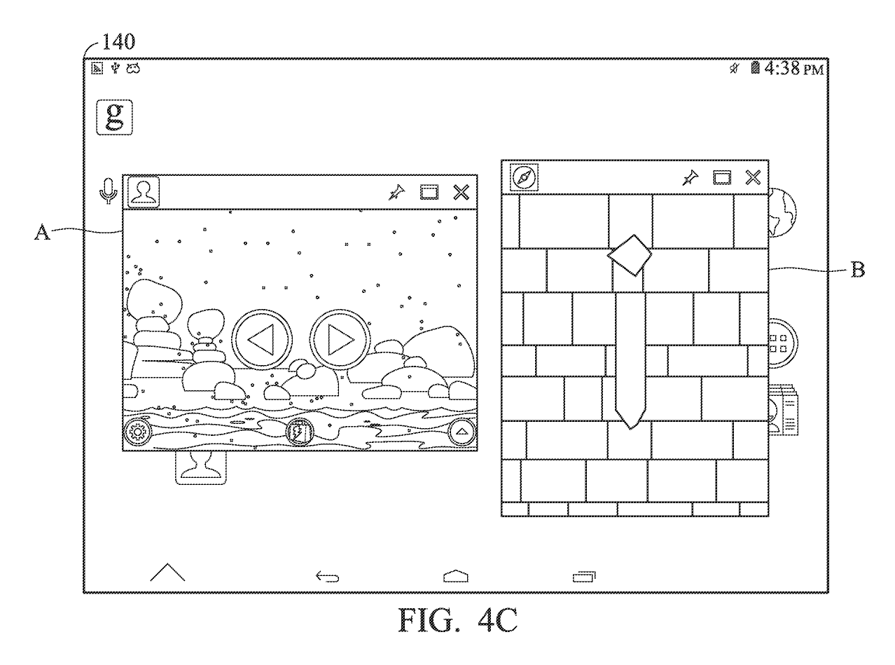

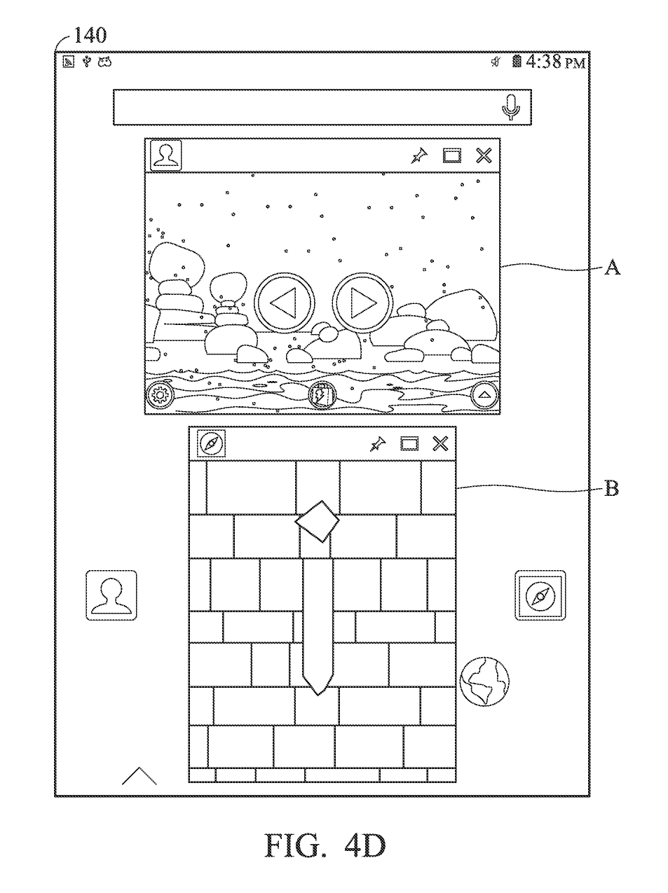

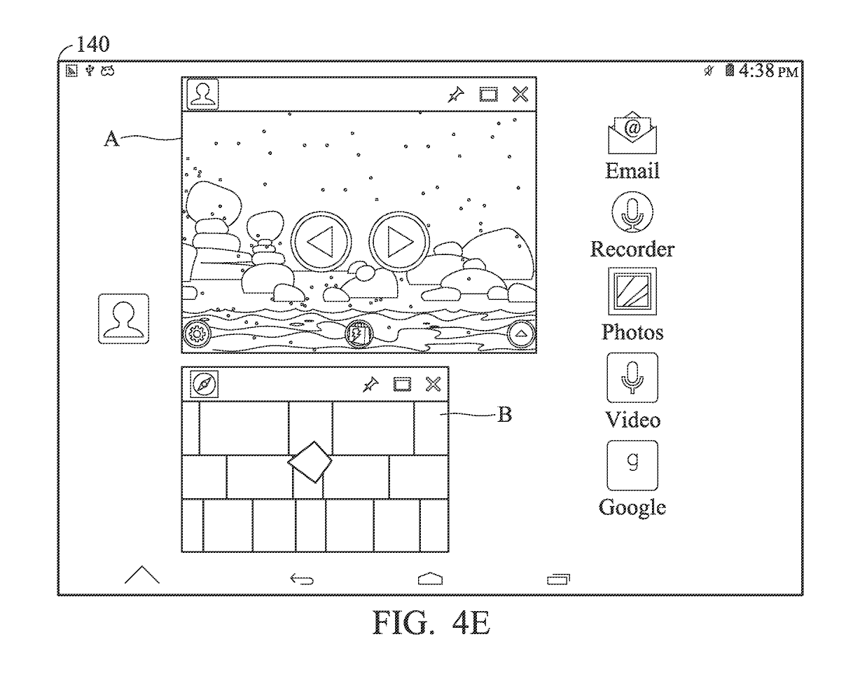

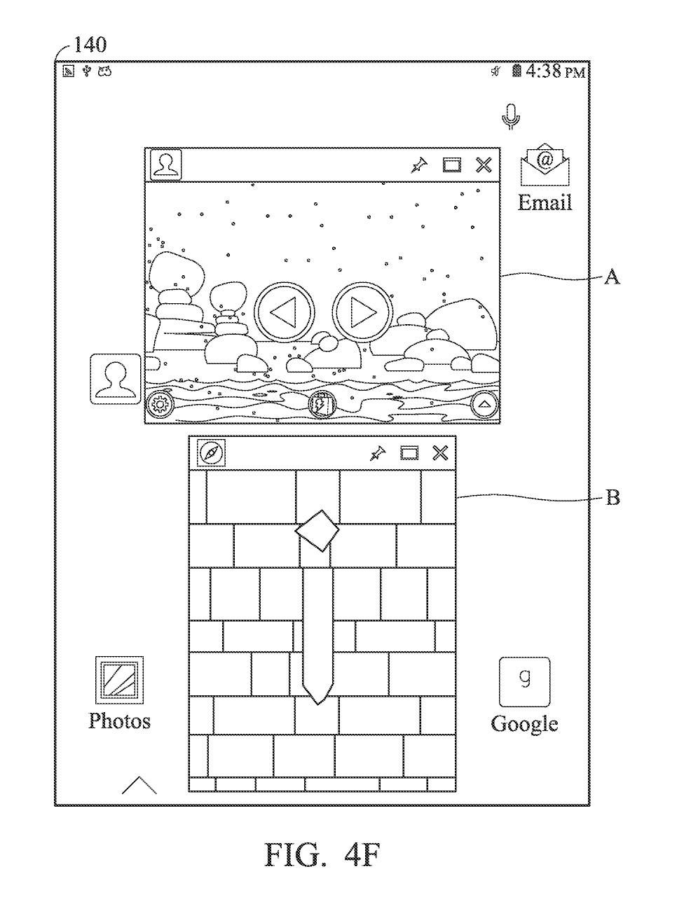

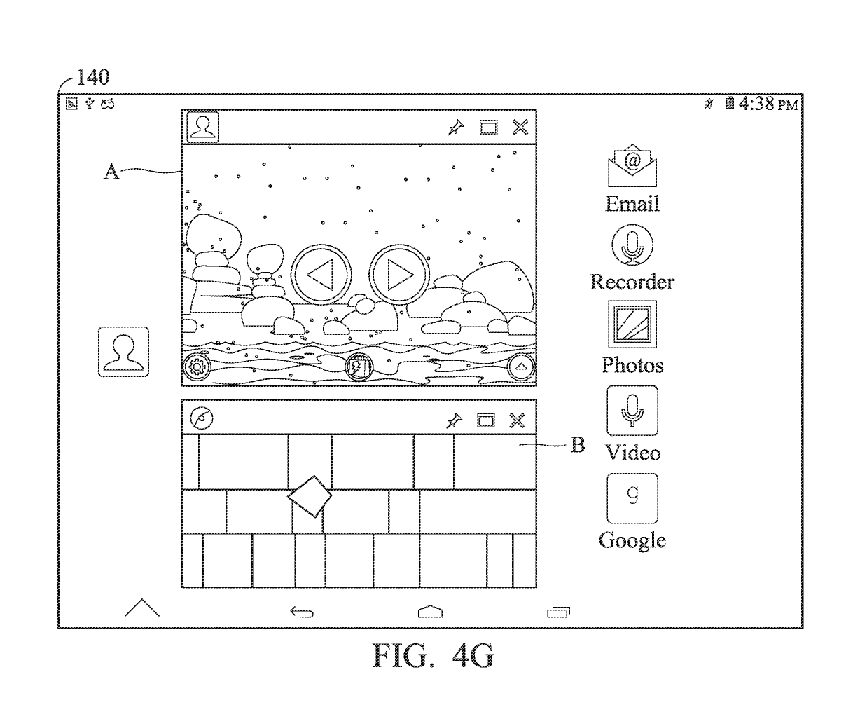

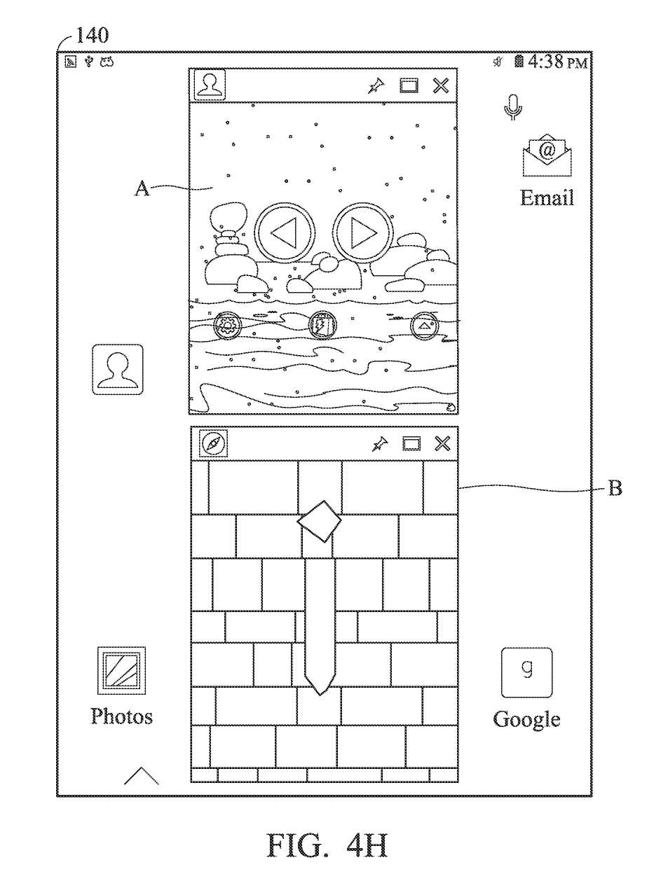

FIG. 4A is a schematic diagram of displaying a display window of application A on the communication device 100 according to an embodiment of the invention, wherein the display mode of application A is the landscape mode. As shown in FIG. 4A, the display window of application A is displayed in the landscape mode after the above operation of the modules of the communication device 100. FIG. 4B is a schematic diagram of displaying a display window of application B on the communication device 100 according to an embodiment of the invention, wherein the display mode of application B is the portrait mode. As shown in FIG. 4B, the display window of application B is displayed in the portrait mode after the above operation of the modules of the communication device 100.

The communication device 100 disclosed in the invention is not only limited to display a display window of one application at a time, but also be able to display multiple windows of multiple applications at the same time. FIG. 4C is a schematic diagram of displaying display windows of application A and application B on the communication device 100 at the same time according to an embodiment of the invention, wherein the first configuration information of application A indicates that the first display mode of application A is the landscape mode and the second configuration information of application B indicates that the second display mode of application B is the portrait mode. The package management module 110 obtains the first configuration information and the second configuration information and determines that the first display mode of application A is landscape mode and the second display mode of application B is the portrait mode. The activity management module 120 sets the first display configuration of application A to a landscape display configuration and sets the second display configuration of application B to a portrait display configuration according to the first display mode and the second display mode. Then the window management module 130 configures the first display window of application A and the second display window of application B according to the first display configuration and the second display configuration. Lastly, as shown in FIG. 4C, the display module 140 displays the first display window of application A in the landscape mode and displays the second display window of application B in the portrait mode. Application A and application B can be displayed on the display module 140 by their own display modes and their display modes will not be affected by each other, so that the problems of the display window changing to black or reporting an error message will not occur.

Note that the first display mode and the second display mode can be the same display mode or different display modes. When the first display mode and the second display mode are the same display mode, the display module 140 displays the first application and the second application according to the display configuration of the display mode at the same time. When the first display mode and the second display mode are different display modes, the display module 140 will display the first application according to the first display configuration of the first display mode and display the second application according to the second display configuration of the second display mode. In addition, the first application and the second application are only used to illustrate the embodiments of the invention, but the invention should not be limited thereto. The communication device 100 can also support displaying more applications (e.g. the third application and the fourth application) at the same time. The communication device 100 can adaptively display multiple windows corresponding to applications on the display module 140 at the same time, wherein the multiple display windows may cross, overlap or not overlap with each other.

FIG. 4D is a schematic diagram of displaying display windows of application A and application B on the communication device 100 at the same time according to another embodiment of the invention, wherein the first configuration information of application A indicates that the first display mode of application A is the landscape mode and the second configuration information of application B indicates that the second display mode of application B is the portrait mode. Similarly, as shown in FIG. 4D, the display module 140 displays the first display window of application A in the landscape mode and displays the second display window of application B in the portrait mode, after a similar operation to that in FIG. 4C. Compared with FIG. 4D, in FIG. 4C, the communication device 100 is placed horizontally so that the system display configuration is the landscape display configuration and the display direction of system screen (desktop) of the communication device 100 is the horizontal direction; and in FIG. 4D, the communication device 100 is placed vertically so that the system display configuration is portrait display configuration and the display direction of system screen (desktop) of the communication device 100 is longitudinal direction. In these two situations, the display modes of the display windows of application A and application B have no relationship with the system display configuration of the communication device 100, and application A and application B can be displayed on the display module 140 by their own display modes and their display modes will not be affected by each other. As per the illustration above, when the display modes of application A and application B have been set to landscape mode or portrait mode, the communication device 100 will not configure the display windows of application A and application B according to the system display configuration. Therefore, when the direction of the communication device 100 is changed, the display modes of application A and application B will not be affected.

FIGS. 4E-4F are schematic diagrams of displaying display windows of application A and application B on the communication device 100 at the same time according to another embodiment of the invention, wherein the first configuration information of application A indicates that the first display mode of application A is the landscape mode but the second configuration information of application B does not include any display mode information, so the second configuration information of application B does not indicate application B is which display mode. In addition, in FIG. 4E, the communication device 100 is placed horizontally (i.e. the sensing direction of the communication device 100 is a horizontal direction), while the communication device 100 is placed vertically (i.e. the sensing direction of the communication device 100 is a longitudinal direction) in FIG. 4F. As per the operation of the communication device 100 described above, in FIG. 4E, display module 140 displays the display window of application A in the landscape mode, and displays the display window of application B also in the landscape mode. In FIG. 4F, display module 140 displays the display window of application A in the landscape mode, and displays the display window of application B in the portrait mode. In this embodiment, the communication device 100 sets the display configuration of application B according to the system display configuration because the display mode of application B has not been set in advance. In FIG. 4E and FIG. 4F, the system display configuration is set to the landscape display configuration and portrait display configuration respectively. Therefore, in FIG. 4E, the display configuration of application B is indicated to the system display configuration, i.e. landscape display configuration, and in FIG. 4F, the display configuration of application B is indicated to the system display configuration, i.e. portrait display configuration. As shown in FIG. 4E and FIG. 4F, when the user changes the direction of the communication device 100 from the horizontal direction (FIG. 4E) to the longitudinal direction (FIG. 4F) by rotating the communication device 100, the sensing module of the communication device 100 will detect the change in the direction of the communication device 100, and then the system display configuration will be updated (from the landscape display configuration to the portrait display configuration) accordingly, and the display direction of the system screen (desktop) will be changed from the landscape mode to the portrait mode. Since the display configuration of application B is indicated to the system display configuration, the display configuration of application B will be changed from the landscape mode to the portrait mode and the direction of the display window of application B will also be changed from the horizontal direction to the longitudinal direction to be consistent with the system display configuration of the communication device 100.

In another embodiment of the invention, if the first configuration information of application A also does not indicate the display mode of application A in advance, the display configurations of application A and application B are both indicated to the system display configuration. As shown in FIG. 4G and FIG. 4H, in this embodiment, when the communication device is placed horizontally (i.e. the sensing direction is horizontal) the display windows of application A and application B will be displayed in landscape mode; and when the communication device is placed vertically (i.e. the sensing direction is longitudinal) the display windows of application A and application B will be displayed in portrait mode. When the direction of the communication device 100 is rotated from the horizontal direction to the longitudinal direction, the system screen (desktop) of the communication device 100 will be changed and the direction of the display windows of application A and application B will also be changed accordingly.

In other embodiments of the invention, for configuration information that does not indicate the application's display mode in advance, the communication device sets the display configuration of the application according to the system display configuration, and can also set the display configuration of the application according to the landscape mode or portrait mode directly. In some embodiments, for the configuration information of different applications in which display modes of the applications are not indicated in advance, the communication device can set the display configurations of the different applications according to different display modes. For example, the display configuration of the first application is indicated to the landscape display configuration or the display configuration of the second application is indicated to the portrait display configuration.

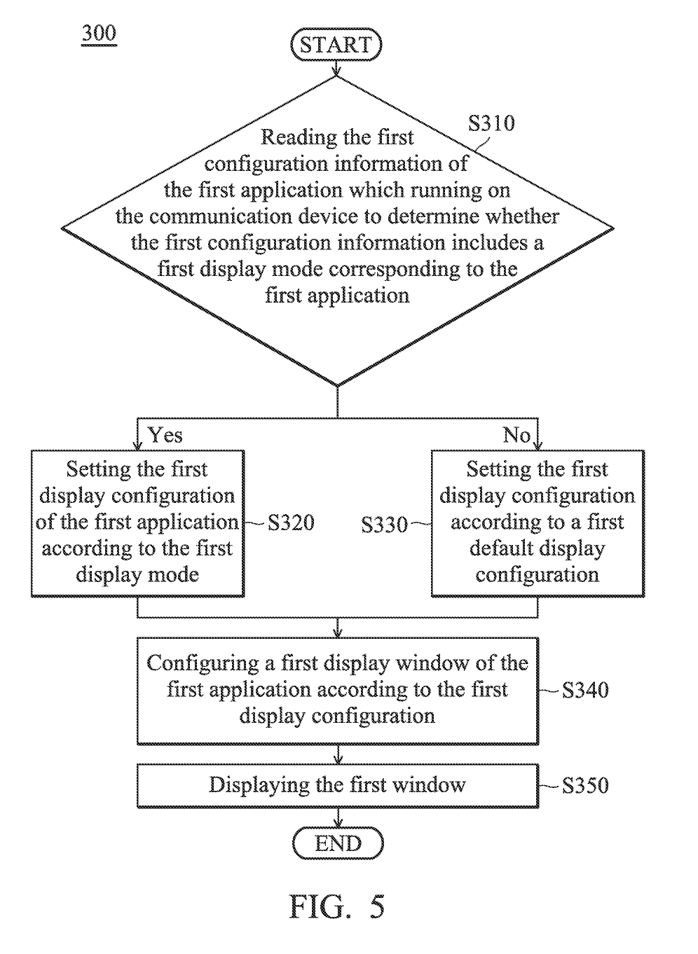

FIG. 5 is a flow chart 300 illustrating the multi-window display method according to an embodiment of the invention. The multi-window display method is applied to a communication device 100 supporting display of multiple windows, wherein the multiple windows comprise a first display window configured to display a first application which is running on the communication device 100. In step S310, the package management module 110 of the communication device 100 reads the first configuration information of the first application which is running on the communication device 100 to determine whether the first configuration information of the first application includes a first display mode corresponding to the first application. In step S320, when the first configuration information of the first application includes the first display mode, the activity management module 120 will set the first display configuration of the first application according to the first display mode. In step S330, when the first configuration information of the first application doesn't include the first display mode, the activity management module 120 will set the first display configuration according to a first default display configuration. In step S340, the window management module 130 of the communication device 100 configures a first display window of the first application according to the first display configuration. In step S350, the display module 140 displays the first window. In an embodiment of the invention, the first display mode is landscape mode or portrait mode. The first default display configuration may be landscape display configuration, portrait display configuration or system display configuration.

In addition, the multiple windows also comprise a second display window configured to display a second application which is running on the communication device 100. The multi-window display method further comprises the following steps. The package management module 110 reads the second configuration information of the second application to determine whether the second configuration information includes a second display mode corresponding to the second application. When the second configuration information includes the second display mode, the activity management module 120 will set the second display configuration of the second application according to the second display mode. When the second configuration information doesn't include the second display mode, the activity management module 120 will set the second display configuration to a second default display configuration. The window management module 130 configures a second display window of the second application according to the second display configuration. Then the display module 140 displays the second window. In an embodiment of the invention, the second display mode is landscape mode or portrait mode. The second default display configuration may be landscape display configuration, portrait display configuration or system display configuration.

When the communication device which supports the multi-window display runs applications with different display modes, unlike traditional communication devices that can't display the applications with different display modes at the same time, various applications with different display modes can be displayed at the same time and accurately, according to the multi-window display method of the invention.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications apparatus, supporting display of multiple windows, wherein the multiple windows comprise a first display window configured to display a first application running running on the communications apparatus, and the communications apparatus comprising:
a package management module, configured to read first configuration information of the first application to determine whether the first configuration information includes a first display mode corresponding to the first application;
a activity management module, configured to set a first display configuration of the first application according to the first display mode when the first configuration information includes the first display mode, or set the first display configuration according to a first default display configuration when the first configuration information doesn't include the first display mode;
a window management module, configured to configure the first display window of the first application according to the first display configuration; and
a display module, configured to display the first display window.

2. The communications apparatus of claim 1, wherein the multiple windows further comprise a second display window configured to display a second application running on the communications apparatus, and
wherein the package management module is further configured to read second configuration information of the second application to determine whether the second configuration information includes a second display mode corresponding to the second application;
the activity management module is further configured to set a second display configuration of the second application according to the second display mode when the second configuration information includes the second display mode, or set the second display configuration according to a second default display configuration when the second configuration information doesn't include the second display mode;
the window management module is further configured to configure the second display window of the second application according to the second display configuration; and
the display module is further configured to display the second display window.

3. The communications apparatus of claim 2, wherein the display module displays the first display window and the second display window at the same time.

4. The communications apparatus of claim 2, wherein the first display mode and/or the second display mode is landscape mode or portrait mode.

5. The communications apparatus of claim 4, wherein when the first display mode or the second display mode is the landscape mode, the activity management module sets the first display configuration or the second display configuration to a landscape display configuration, and when the first display mode or the second display mode is the portrait mode, the activity management module sets the first display configuration or the second display configuration to a portrait display configuration.

6. The communications apparatus of claim 2, wherein the first default display configuration and/or the second default display configuration is a landscape display configuration or a portrait display configuration.

7. The communications apparatus of claim 2, further comprising:
a sensing module, configured to detect and generate a sensing direction of the communications apparatus, wherein the activity management module is further configured to set a system display configuration of the communications apparatus according to the sensing direction.

8. The communications apparatus of claim 7, wherein the first default display configuration and/or the second default display configuration is the system display configuration.

9. The communications apparatus of claim 8, wherein the sensing module is further configured to detect a change of the sensing direction of the communications apparatus, and when the change is detected, the activity management module updates the system display configuration according to the change, and sets the first default display configuration and/or the second default display configuration to the updated system display configuration.

10. The communications apparatus of claim 7, wherein when the sensing direction is a horizontal direction, the activity management module sets the system display configuration to the landscape display configuration, and when the sensing direction is a longitudinal direction, the activity management module sets the system display configuration to the portrait display configuration.

11. A multi-window display method, applied for a communication device supporting display of multiple windows, wherein the multiple windows comprise a first display window configured to display a first application running on the communications apparatus, and the multi-window display method comprising:
obtaining, by a package management module of the communication device, first configuration information of the first application to determine whether the first configuration information includes a first display mode corresponding to the first application;
setting, by a activity management module of the communication device, a first display configuration of the first application according to the first display mode when the first configuration information includes the first display mode, or setting the first display configuration according to a first default display configuration when the first configuration information doesn't include the first display mode;
configuring, by a window management module of the communication device, the first display window of the first application according to the first display configuration; and
displaying, by a display module of the communication device, the first display window.

12. The multi-window display method of claim 11, wherein the multiple windows further comprise a second display window configured to display a second application running on the communications apparatus, and the multi-window display method further comprises:
obtaining, by the package management module, second configuration information of the second application to determine whether the second configuration information includes a second display mode corresponding to the second application;
setting, by the activity management module, a second display configuration of the second application according to the second display mode when the second configuration information includes the second display mode, or setting the second display configuration according to a second default display configuration when the second configuration information doesn't include the second display mode;
configuring, by the window management module, the second display window of the second application according to the second display configuration; and
displaying, by the display module, the second display window.

13. The multi-window display method of claim 12, further comprising:
displaying, by the display module, the first display window and the second display window at the same time.

14. The multi-window display method of claim 12, wherein the first display mode and/or the second display mode is landscape mode or portrait mode.

15. The multi-window display method of claim 14, further comprising:
setting, by the activity management module, the first display configuration or the second display configuration to a landscape display configuration when the first display mode or the second display mode is the landscape mode; and
setting, by the activity management module, the first display configuration or the second display configuration to a portrait display configuration when the first display mode or the second display mode is the portrait mode.

16. The multi-window display method of claim 12, wherein the first default display configuration and/or the second default display configuration is a landscape display configuration or a portrait display configuration.

17. The multi-window display method of claim 12, further comprising:
detecting and generating, by a sensing module, a sensing direction of the communications apparatus; and
setting, by the activity management module, a system display configuration of the communications apparatus according to the sensing direction.

18. The multi-window display method of claim 17, wherein the first default display configuration and/or the second default display configuration is the system display configuration.

19. The multi-window display method of claim 18, further comprising:
detecting, by the sensing module, a change of the sensing direction of the communications apparatus, when the change is detected;
updating, by the activity management module, the system display configuration according to the change; and
setting, by the activity management module, the first default display configuration and/or the second default display configuration to the updated system display configuration.

20. The multi-window display method of claim 17, further comprising:
setting, by the activity management module, the system display configuration to the landscape display configuration when the sensing direction is a horizontal direction; and
setting, by the activity management module, the system display configuration to the portrait display configuration when the sensing direction is a longitudinal direction.
